(19) United States
(12) Patent Application Publication
(10) Pub. No.: US 2003/0050967 A1
(43) Pub. Date: Mar. 13, 2003

(54) Apparatus and method for optimal selection of IP modules for design integration

(76) Inventor: William F. Bentley, New Boston, NH (US)

Correspondence Address: ANTHONY T. CASCIO, ESQ., 423 BROADWAY AVE., SUITE 314, MILBRAE, CA, 94030-1905, US

(21) Appl. No.: 09/953,579

(22) Filed: Sep. 11, 2001

(51) Int. Cl. G06F 15/16; G06F 17/00

(52) U.S. Cl. 709/203; 707/104.1

(57) ABSTRACT

The ease of integrating intellectual property modules obtainable from a plurality of intellectual property sources is made using a first web page and a pallet window. The first web page is stored at a server and viewable at a user computer. The first web page includes an integration environment field and at least one active region. The integration environment field is adapted to contain a user selected one of a plurality of indicia wherein each of the indicia identifies a respective one of a plurality of integration environments. Each of the integration environments has a plurality of modules associated therewith. The active region is user selectable when the web page is viewed at the user computer. The pallet window is viewable at the user computer upon selection of the active region. The pallet window includes a pallet field and an integration coefficient field. The pallet field is adapted to contain a plurality of second indicia wherein each of the second indicia identifies a respective one of a plurality of modules within all of the integration environments. The integration coefficient field is adapted to contain an integration coefficient computed as a function of a number of the modules from the user selected one of the integration environments and a number of the modules from other ones of the integration environments when the second indicia are contained in the pallet field.

### BACKGROUND OF THE INVENTION

1. Field of the Invention

The present invention relates generally to selection of intellectual property modules to be integrated into a single design, and, more particularly, to apparatus and methods practiced in conjunction with an integration environment to determine a relative ease of integration of a collection of the modules into the integration environment and a relative compatibility of each of the modules to each other.

2. Description of the Related Art

In the design of processes, machines and articles of manufacture, one skilled in the art typically constructs such design as a combination of known processes or functional modules, which may collectively be referred to herein as intellectual property modules. For example, a complex design may first be defined by a plurality of functional subparts that interact within the design to produce the desired end result of the design. Secondly, a search may then be performed for one or more sources of known intellectual property modules that perform the function of each respective one of the subparts. Ideally, when these known modules are assembled and interconnected in accordance with the design, the desired end result of the design should be obtained.

However, it is well known that, when obtaining such functional modules from different sources, a module from one such source may be incompatible with a module from another such source. It is also well known that modules obtainable from a single source may also be incompatible with each other because of version and revision level differences. The resultant high probability of incompatibility between two or more modules in the design may disadvantageously degrade or limit the desired functional end result of the design. Furthermore, the design process may also be disadvantageously lengthened or result in increased effort to accomplish the design.

For example, a skilled artisan may, in constructing a specific design, utilize a workstation programmed with computer aided design (CAD) software commercially available from a specific vendor. The CAD software may contain a library of known modules. However, the design itself may call for one or more modules not contained in the library. The artisan must then locate such modules from other sources, such as libraries in other CAD software. Accordingly, the artisan then may have the task of integrating these externally located modules into the library of the currently utilized CAD software. A disadvantage and limitation of this approach to integration is that the artisan, other than through past experience with the same or similar modules, has no objective assessment of the relative ease or difficulty that such externally located modules may be integrated into the current library.

Similarly, catalogs of IP modules exist wherein such IP modules are sortable by function, supplier, and the case of integrated circuit modules, clock rate, process and type. For example, the artisan may access such catalog and display all available modules by function. The artisan may then choose the modules desired and drag and drop each of the modules into a pallet window. Alternatively, the artist and may display all such modules by supplier and choose the necessary modules from a desired supplier and if all such modules are not provided by such supplier choose the remaining modules from one or more different suppliers. In choosing modules, each of the chosen modules is again dragged and dropped into the pallet.

In a specific example, the designer may need to choose a particular IP module for system on chip (SOC) integration. The designer may be working within an integration environment wherein IP modules within the system communicate with a controller along a separate channel unique to each module. However, the designer may be unsuccessful in locating a particular module for a required function in the proposed design. The designer may find a module performing the requisite function within another integration environment wherein such modules communicate along a time multiplex bus.

The difference between two modules is that, for the channel communication environment, the module will have a channel manager, whereas for the multiplexed bus environment, the module will have an interrupt and acknowledge input. Moreover, the pin assignments for the module in the multiplexed bus environment do not readily allow for this module to be used in the channel communication environment for which it was not designed. However, the module for the multiplexed bus environment may be modified to work in the channel communication environment.

For example, the skilled artisan may know of additional devices that adapt the to work within the channel communication environment. Additionally, there may exist application notes or other technical data sheets that describe possible adaptations of the module for the multiplexed bus environment to the channel communication environment. However, neither personal knowledge, application notes nor technical data sheets provide to the skilled artisan an objective assessment of the relative ease or difficulty of the required adaptation.

Accordingly, it is highly desirous to provide methods and apparatus which would enable a skilled artisan to objectively assess the relative ease or difficulty that such externally located modules may be integrated into the current integration environment. It is also highly desirous to provide a method and apparatus which would allow searching to be performed for modules which, when integrated, obviate or at least minimize the probability of incompatibility between such modules.

### SUMMARY OF THE INVENTION

It is an object of the present invention to overcome one or more disadvantages and limitations of the prior art above enumerated.

According to the present invention, an apparatus for integrating modules obtainable from a plurality of intellectual property sources into a single design includes a first web page and a pallet window. The first web page is stored at a server and viewable at a user computer. The first web page includes an integration environment field and at least one active region. The integration environment field is adapted to contain a user selected one of a plurality of indicia wherein each of the indicia identifies a respective one of a plurality of integration environments. Each of the integration environments has a plurality of modules associated therewith. The active region is user selectable when the web page is viewed at the user computer. The pallet window is viewable at the user computer upon selection of the active region. The pallet window includes a pallet field and an integration coefficient field. The pallet field is adapted to contain a plurality of second indicia wherein each of the second indicia identifies a respective one of a plurality of modules within all of the integration environments. The integration coefficient field is adapted to contain an integration coefficient computed as a function of a number of the modules from the user selected one of the integration environments and a number of the modules from other ones of the integration environments when the second indicia are contained in the pallet field.

A feature of the above invention is that each of the modules not within the integration environment may be assigned a compatibility coefficient prior to selecting such modules. The skilled artisan would then normally choose for the pallet those modules having a compatibility coefficient indicating a relatively higher degree of compatibility than another module providing the substantially identical function with a relatively lower degree of compatibility. The skilled artisan could also rely in the selection process on extraneous information, such as information known to the artisan through prior experience, to reject a the module with the higher degree of compatibility in favor of the module with the lower degree of compatibility.

These and other objects, advantages and features of the present invention will become readily apparent to those skilled in the art from a study of the following description of the exemplary Preferred Embodiments when read in conjunction with the attached Drawing and Appended claims.

### BRIEF DESCRIPTION OF THE DRAWING

FIG. 1 is a schematic diagram of one embodiment of an apparatus useful for practicing the present invention;

FIGS. 2A-I are illustrative of a home page window and its associated windows useful for practicing the present invention;

FIGS. 3A-B are illustrative of a view/edit pallet window and its associated windows;

FIG. 4 is illustrative of a search window;

FIG. 5 is illustrative of a substitution window; and

FIG. 6 is illustrative of another substitution window.

### DESCRIPTION OF THE EXEMPLARY PREFERRED EMBODIMENTS

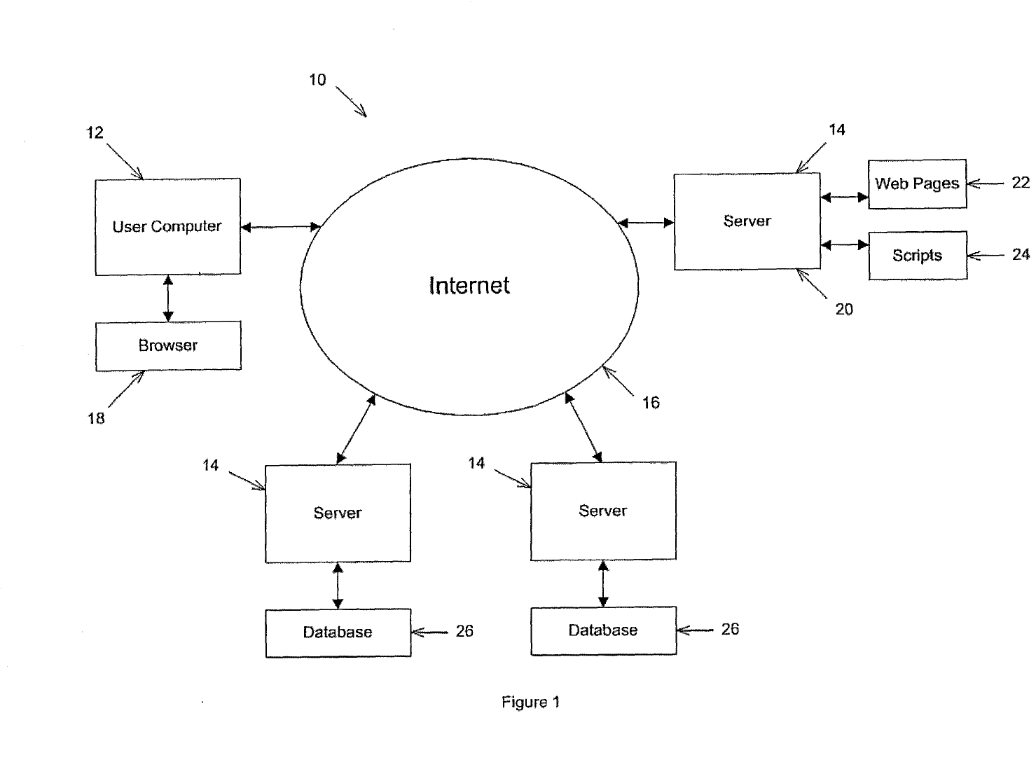

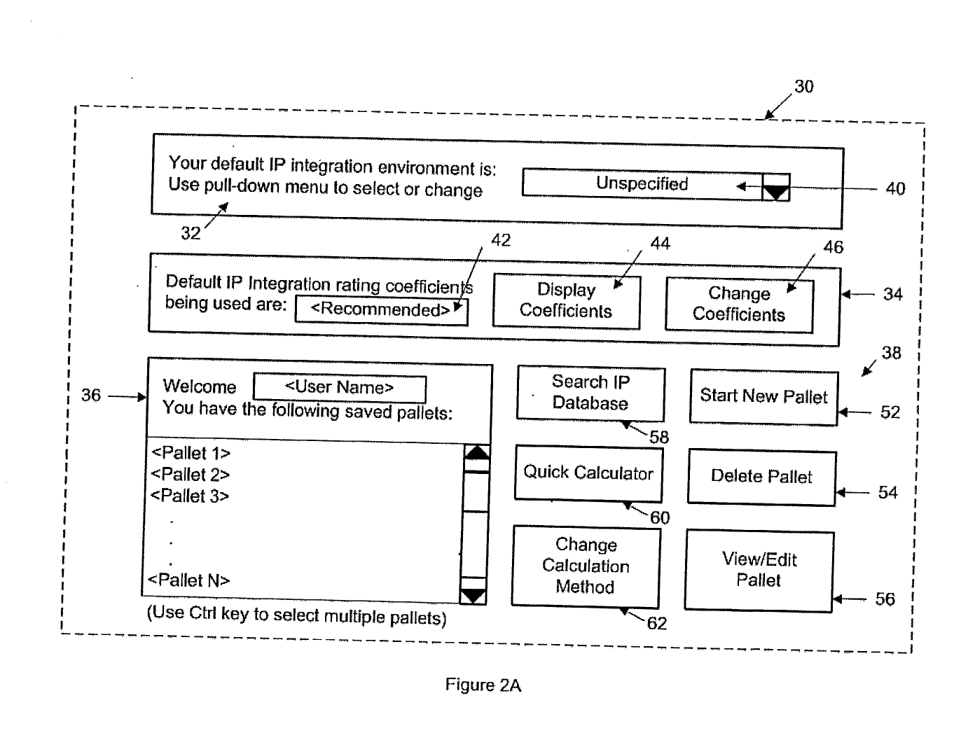

Referring now to FIG. 1, there is shown a computer network 10 in which a user computer 12 may be selectively connected to the plurality of servers 14 through a computer network 16, such as the Internet. Although the preferred embodiment of the present invention is operable over the Internet, the computer network 16 may be any public or private local or wide area network. The user computer 12 contains browser software 18 to enable the user computer 12 to communicate through the network 16 with any other servers 14, as is well known. One of the servers 14 is identified herein as a host server 20. The host server 20 includes a plurality of web pages 22 and a plurality of scripts 24. The remaining servers 14 are each in communication with a respective database 26.

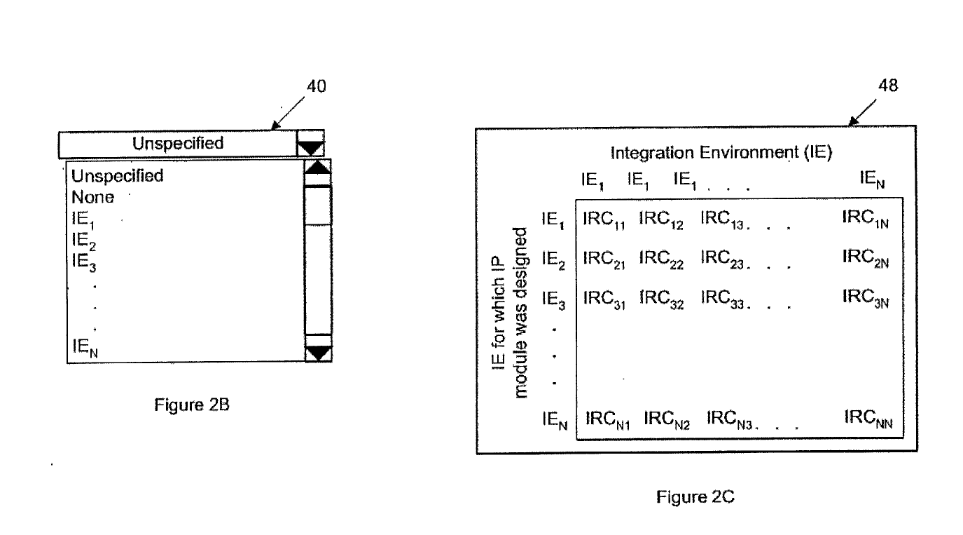

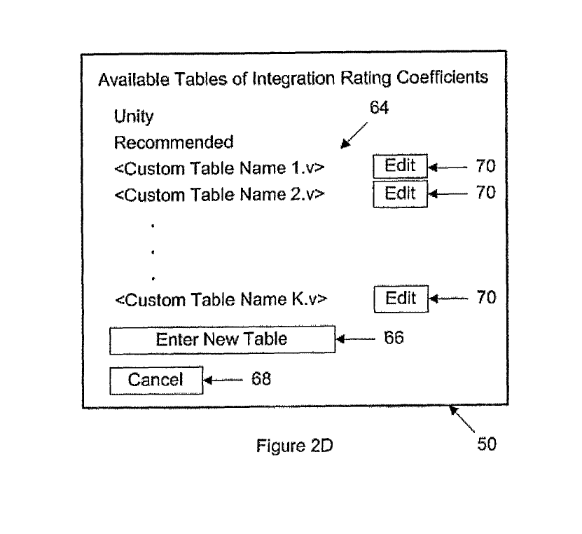

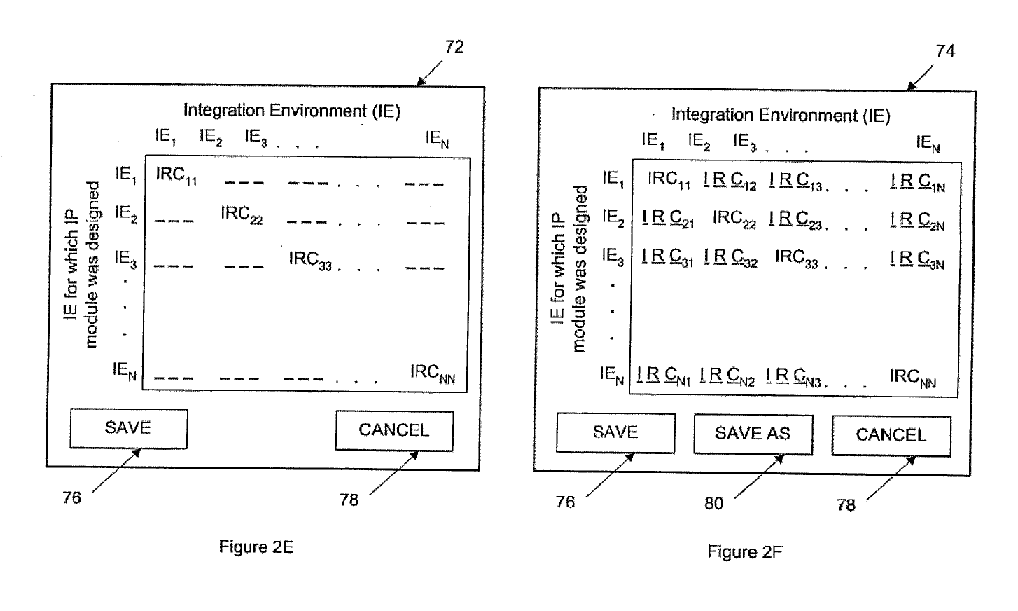

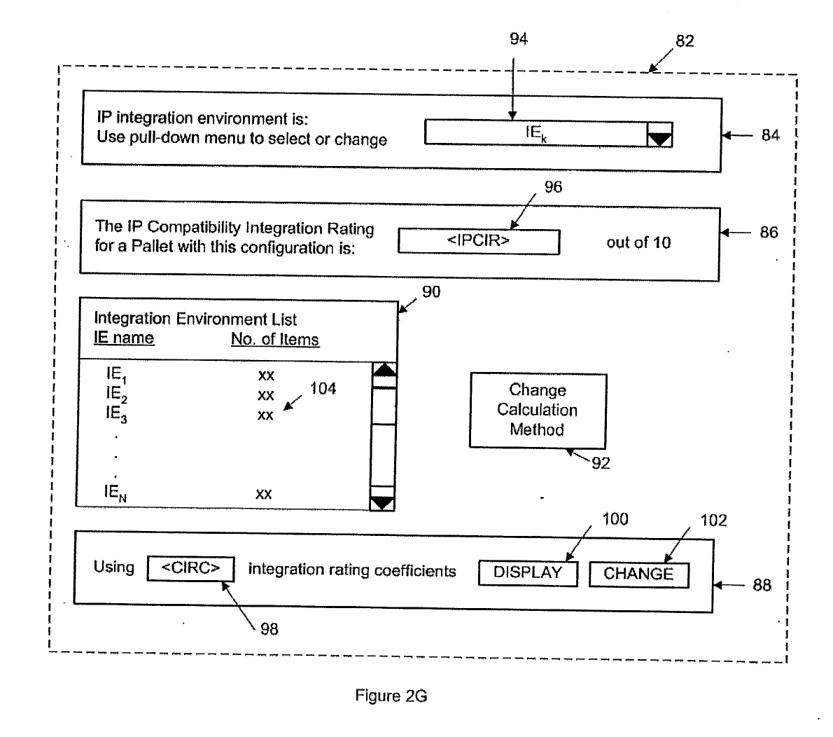

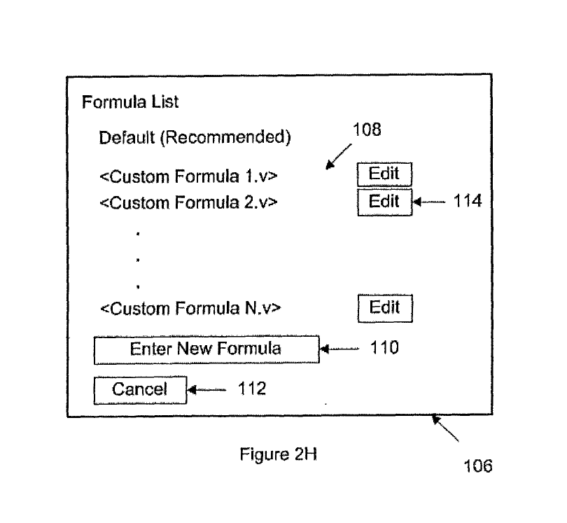

The scripts 24 stored on a suitable computer readable medium at the host server 20 provide the novel methods and apparatus of the present invention. The web pages 22, when accessed by the browser software 18 and displayed at the user computer 12, provide a user interface to the scripts 24 in various windows, as described below in reference to FIGS. 2-6, which alone or in combination with each other also provide other novel methods and apparatus of the present invention. Each database 26 contains a collection of intellectual property modules. A collection of such modules in each database 26 may be from one or more integration environments, as described below, wherein each collection is associated with a respective one of a plurality of the integration environments.

Although the computer network 16 in a preferred embodiment of the present invention may be the Internet, the computer network 16 may be any public or private local or wide area network. Alternatively, the computer network 10 may be a standalone workstation in which the web pages 22 and the contents of the databases 26 are locally stored and readable by an application program executable at the workstation, similar to user computer 12, which implements the scripts 24 also stored at the workstation.

Referring now to FIG. 2A, there is shown a start window 30 generated by a one of the web pages 22 when accessed by the browser 18 and displayed at the user computer 12. The start window 30 includes a first banner 32, a second banner 34, a pallet list 36 and an active region 38.

The first banner 32 includes a pulldown menu 40 to display a default integration environment for a collection of intellectual property modules. The pulldown menu 40 initially loads, as is conventionally known, with a default shown herein as “Unspecified.” As best seen in FIG. 2B, the pulldown menu 40 includes a selectable list of integration environments identified by their respective indicia, IE₁, IE₂, IE₃ . . . IEₙ. Each of the indicia for integration environments may, for example, refer to a respective one of manufacturers, suppliers or distributors of intellectual property modules. Integration environments can also be defined using criteria defined or selected by a user. Within each of these integration environment are a collection of intellectual property modules.

Furthermore, certain intellectual property modules may not be associated with any particular integration environment and are collectively assigned to an integration environment identified by the indicia NONE. The NONE environment is treated in all respects, however, equally with all other integration environments. Accordingly, for purposes of this disclosure and as seen in any figure of the Drawing, any of the indicia IE₁, IE₂, IE₃ . . . IEₙ may be assigned the NONE indicia, for example, IE₁=NONE.

The second banner 34 includes a variable text field 42, a display coefficients button 44 and a change coefficients button 46. The variable text field 42 displays the default integration rating coefficients. The display coefficients button 44 is linked to a table of coefficients window 48, as best seen in FIG. 2C, which contains a table of integration rating coefficients, IRC_{xy}, with the list of integration environments, IEₓ, being displayed along the abscissa and the integration environment, IE_{y}, that the IP module is designed for being displayed along the ordinate. The change coefficients button 46 is linked to an available table of integration rating coefficients window 50, as best seen in FIG. 2D. As described in further detail below, the integration rating coefficients are numeric values relating to the relative ease of using intellectual property modules designed for one particular integration environment, IE_{y}, within any integration environment IEₓ.

The pallet list 36 includes a list of user selectable indicia for pallets, wherein each of the pallets are identified by a respective one of indicia Pallet_1, Pallet_2, Pallet_3 . . . Pallet_N. A pallet is a collection of intellectual property modules wherein each collection is selected by a user and saved as a pallet as described below. Selection may typically be made as an HTML form input value. A pallet may be saved in one of the databases 26 or locally within the user computer 12. Local saving may be preferable for enhanced security when such pallets are highly proprietary.

The active region 38 includes a plurality of buttons, selection of which causes either a particular one of the web pages 22 to be displayed in a window or one of the scripts 24 to be executed. The buttons may be individually disposed in the window or arranged within a button bar, may be enabled as hot spots within a graphic image utilizing server side or client side scripting, form input buttons using an HTML input tag, Java script enabled buttons, or any other conventional way of implementing button selection for subsequent response within a web page. In a preferred embodiment of the present invention, the active region 38 includes a start a new pallet button 52, a delete pallet button 54, a view/edit pallet button 56, a search IP database button 58, a quick calculator button 60 and a change calculation method button 62. The features associated with each of these buttons within the active region 38 are described in further detail hereinbelow.

With reference returning to FIG. 2D, the available tables of integration rating coefficients window 50 includes a list 64 of available tables identified by active indicia, such as generated by HTML form input tags, that are individually user selectable, an enter new table button 66, a cancel button 68 and a plurality of edit buttons 70. Each edit button 70 is associated with a respective one of the indicia in the list 64. In a preferred embodiment of the present invention, one of the indicia in the list 64 is identified by UNITY, and another one of the indicia in the list 64 is identified by RECOMMENDED. Neither the UNITY or RECOMMENDED indicia have an associated edit button 70.

In the unity table, all of the values, IRC_{xy}, are equal to one. In the RECOMMENDED table, each of the values, IRC_{xy}, are preselected in accordance with predetermined criteria. In addition, custom tables may also be defined and identified by indicia CUSTOM TABLE NAME 1.v, CUSTOM TABLE NAME 2.v . . . CUSTOM TABLE NAME K.v, wherein the “v” refers to a version number, which is incremented after each edit of the table. Alternatively, version numbers need not be used. Each table is stored in one of the databases 26 in a conventional manner. Selection of one of the indicia in the list 64 will call the respective table from the database 26 to be displayed in the table of coefficients window 48 (FIG. 2C).

Selection of the enter new table button 66 opens an enter new table window 72, as best seen in FIG. 2E. The new table window 72 includes a table of integration rating coefficients, IRC_{xy}. Similar to the table 48 of FIG. 2C, the abscissa includes the available integration environments, IEₓ, and the ordinate includes the integration environment, IE_{y}, the IP module is designed for. The new table window 72 also includes a save table button 76 and cancel button 78.

In the new table window 72, the integration rating coefficients, IRC_{xy}, are user insertable values as indicated by the dashed under lines under empty values of the coefficients, IRC_{xy}. For those values of the integration rating coefficients, IRC_{xy}, wherein the integration environment, IEₓ, and the integration environment the IP module is designed for, IE_{y}, are the same, the new table window 72 may display default values for the values of the integration rating coefficients, IEⱼⱼ, wherein x=y=j. These default values, if used, would be selected in accordance with the formulas used to compute the compatibility integration rating for a pallet as described below. The default values may be either user modifiable or fixed.

Selection of an edit button 70 opens an edit table window 74 preloaded with the entries of the corresponding custom table, as best seen in FIG. 2F. In the edit table window 74, the integration rating coefficients, IRC_{xy}, are user editable values as indicated by the dashed lines under pre-existing values of the integration rating coefficients, IRC_{xy}. Similarly as described above in conjunction with the new table window 72, those values of the integration rating coefficients, IRC_{xy}, wherein the integration environment, IEₓ, and the integration environment the IP module is designed for, IE_{y}, are the same, the new table window 72 may display the above described default values for the values of the integration rating coefficients, IEⱼⱼ. In the edit table window 74, these default values may also be either editable or fixed. In addition to the save table button 76 and the cancel button 78, the edit table window 74 also includes a save-as button 80.

Selection of the save table button 76 from the edit table window 74 will cause the table to be saved in the database 26 under the custom table name indicia in the list 64 associated with the edit button 70 that had been selected from the available tables of integration rating coefficients window 50 (FIG. 2D). If version numbers are used, the version numbers in the custom table name indicia will be incremented. Selection of the save button 76 from the new table window 72 or the save as button 80 from the edit table window 74 will cause the table to be saved in the database 26 under a new custom table name indicia which will be inserted into the list 64 of available table names of FIG. 2D. The new custom table names and version numbers may be generated by the scripts 24, or such names may be entered by the user, either of which is conventionally known.

Selection of the save button 74 or the save as button 80 will cause the entries in the new table window 72 or the table window 76 to be sent to the scripts 24 at the server 14, typically as HTML form input values. The cancel button 78 in both the new table window 72 and edit table window 74 will close the window without transfer of any data to the server 14.

Referring now to FIG. 2G, there is shown a quick calculator window 82 which is displayed at the user computer 12 upon selection of a quick calculator button 60 (FIG. 2A). The quick calculator window 82 includes a first banner 84, a second banner 86, a third banner 88, an integration environment list 90 and a change calculation method button 92. The quick calculator window 82 provides a “scratchpad” window wherein a user can test various combinations of modules in a test or hypothetical pallet, without the necessity of needing to select a large number of modules from the shared libraries.

The first banner 84 includes a pulldown menu 94 similar to pulldown menu 40 of FIG. 2A. The second banner 86 includes a variable text field 96 in which a value of a compatibility integration rating, calculated as hereinbelow described, is inserted as a calculated result of execution of the scripts 24 and inserted into an HTML document as is conventionally known. The third banner 88 includes a variable text field 98, a display button 100 and a change button 102.

The integration environment list 90 includes an indicia for each of the integration environments, IE₁, IE₂, IE₃ . . . IEₙ, from which IP modules are contained in the currently selected pallet. Associated with each of the indicia in the integration environment list 90 is a variable text field 104. The text field 104 has inserted therein a numerical value for the number of IP modules for each associated one of the integration environments within the hypothetical or test pallet. The information of the text field 104 is stored in the database 26.

The pulldown menu 94 will initially display the selected one of the integration environments, IEₖ, selected from the pulldown menu 40 of FIG. 2A. The pulldown menu 94 also allows for a change of the integration environment while the quick calculation window 82 is displayed.

The variable text field 98 will have inserted therein the name of the table of the integration rating coefficients selected from the list 64 of available tables (FIG. 2D). The display button 100 will display a table of integration rating coefficients currently selected in the window 48 of FIG. 2C. The change button 102 will upon being selected open the available tables of coefficients window 50 or bring such window to the top if already open.

Selection of the change calculation method button 92 opens the formula list window 106, as best seen in FIG. 2H. The formula list window 106 includes a list 108 of indicia identifying formulas, which are implemented as scripts, to calculate the compatibility integration rating. One of the indicia in the list 108 refers to a default or recommended formula for calculating the compatibility integration rating which is disclosed in commonly known, copending application Ser. No. 09/______, filed on even date herewith. The list 108 also includes indicia for custom formula, CUSTOM FORMULA 1.v, CUSTOM FORMULA 2.v . . . CUSTOM FORMULA N.v. The v refers to an optional version number. If used, the version number is incremented, as determined by the scripts, each time the formula is modified. The custom formula may be developed by individual users, user groups, companies, trade organizations or sanctioning bodies.

The formula list window 106 also includes an enter new formula button 110, a cancel button 112 and a plurality of edit buttons 114. Each of the edit buttons 114 is associated with a respective one of the indicia for the custom formula. Selection of the cancel button 112 will close the formula list window 106 with no further action performed. Selection of the entering new formula button 110 or any one of the edit buttons 114 will open an enter/edit formula window 116, best seen in FIG. 21.

Referring now to FIG. 21, there is shown the enter/edit window 116. The enter/edit window 116 includes the text entry box 118 in which formulae may be entered from the user computer 12 when the enter/edit formula window 116 is displayed thereat. The enter/edit formula window 116 also includes a save button 120 and cancel button 122. Selection of the save button 120 will save the entered formula in the text box 118 with the indicia for the name of the custom formula associated with the selected edit button 114. Selection of the cancel button 122 will close the enter/edit window 116 without further action taken.

The enter/edit window 116 also includes a save as button 124 which is an active only upon the enter/edit window 116 being opened from a selection of an edit button 114. The save as button 124 allows the option of an edited formula in the text box 118 to be saved under a new name which results in a new indicia being presented in the list 108 of FIG. 2H.

Similarly, when the enter/edit window 116 is opened from the enter new formula button 110, the user entered formula in the text box 118 will be saved upon selection of the save button 120. In all cases, the formula may be written as scripts saved at the host server 20. The save button 120 and save as button 122 may also be implemented by HTML form input tags.

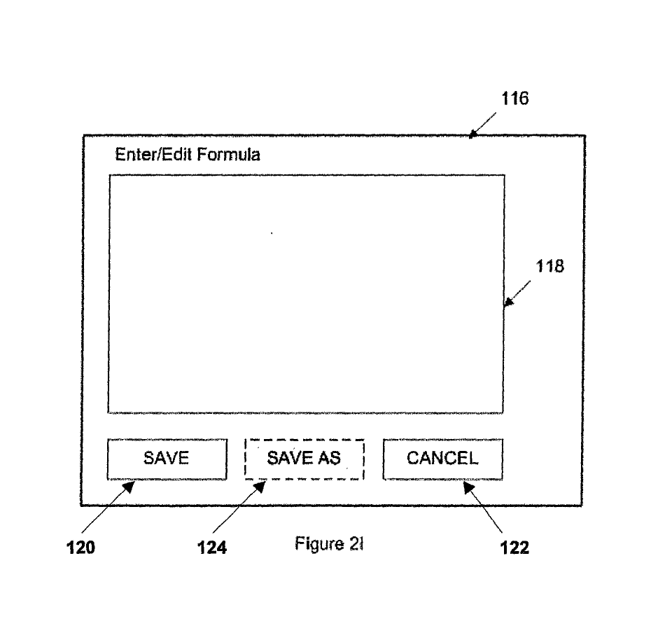

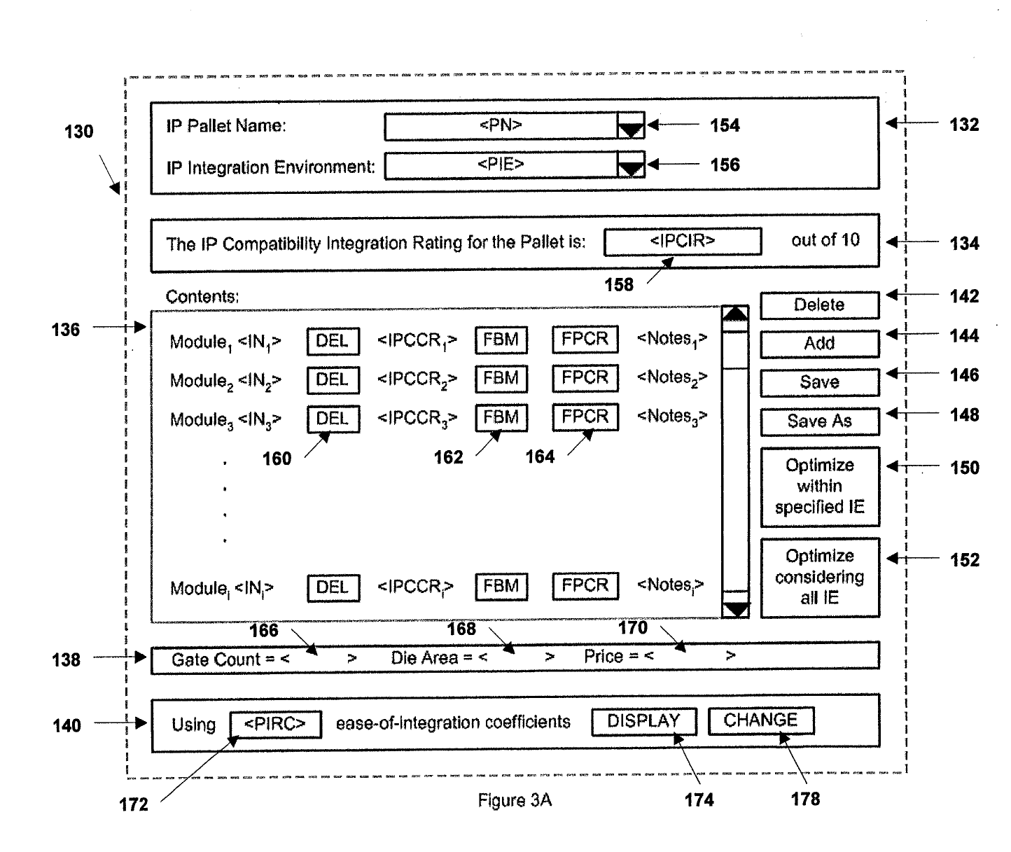

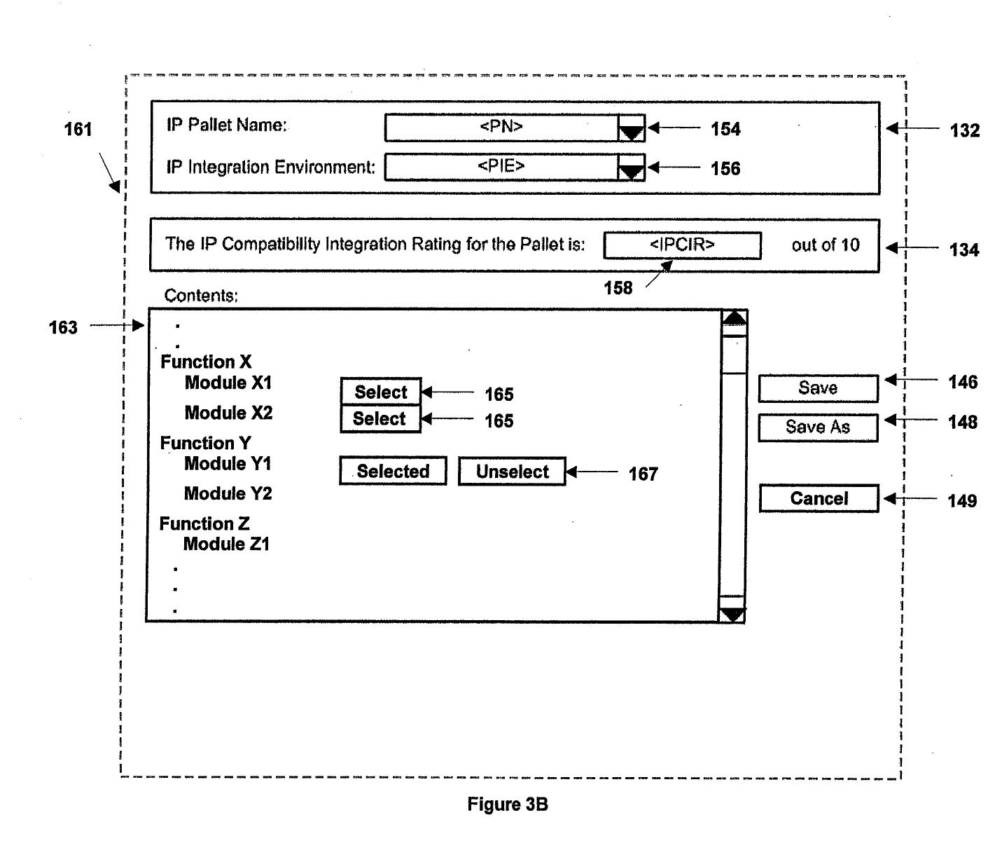

Referring now to FIG. 3A, there is shown a view/edit pallet window 130, which is opened upon selection of the view/edit pallet window button 56 (FIG. 2A). Prior to selection of the view/edit pallet window button 56, one of the indicia for a pallet name in the list 36 is selected. Multiple pallet may be selected by using the control key at the user computer 12 while clicking on various indicia. In such case, selection of the view/edit pallet window button 56 will open multiple view/edit pallet windows 130, one window 130 for each pallet.

The view/edit pallet window 130 includes a pallet integration environment banner 132, a compatibility integration rating banner 134, a contents list 136, a parameter banner 138, and a pallet integration coefficients banner 140. The view/edit pallet window 130 further includes a delete button 142, an add button 144, a save button 146, a save as button 148, a first optimize button 150 and a second optimize button 152.

The pallet integration environment banner 132 includes a pallet name pulldown menu 154 and an integration environment pulldown menu 156. The pallet name pulldown menu 154 will display, when selected, a list of all the pallet names contained in the list 36 (FIG. 2A). When the view/edit pallet window 130 is initially opened, the pallet name pulldown menu 154 will display the name of the selected pallet from the list 36. Selection of another pallet name from the pallet name pulldown menu 154 will cause the contents list 136 and each of the fields, hereinbelow described, within the view/edit pallet window 130 to be updated for the values associated with such pallet in the database 26.

The integration environment pulldown menu 156 is similar to the integration environment pulldown menu 40 (FIG. 2A). Selection of a new integration environment from the integration environment pulldown menu 40 will cause certain fields, hereinbelow described, to be refreshed with new values wherein such values are dependent upon the particular integration environment presently selected. The pallet integration environment banner 132 may further be color coded, either in its text or background, to the currently selected value of the pallet integration environment shown in the pulldown menu 156.

For example, in the compatibility integration rating banner 134 is a variable text field 158. Inserted within the text field 158 is the compatibility integration rating for the current pallet selected within the pallet name pulldown menu 154. This rating is calculated, as hereinabove described. Changing of the integration environment from the pulldown menu 156, although not changing the collection of intellectual property modules in the present pallet, will change the compatibility of each of those modules to that selected integration environment, thereby necessitating that the integration compatibility rating be re-computed.

The contents list 136 includes a listing of the name of each module, Module₁, Module₂, Module₃ . . . Moduleᵢ, used within the collection for the currently selected pallet with each name therein having a respective instantiation number, IN₁, IN₂, IN₃ . . . IN_{I}, associated therewith. The instantiation number refers to the number of times its associated intellectual property module is used within the collection of the currently selected pallet.

Also associated with the name of each module in the contents list 136 is its respective intellectual property compatibility rating, IPCCR₁, IPCCR₂, IPCCR₃ . . . IPCCRᵢ, which is a calculated or assigned number field that contains the compatibility rating of the individual module with in the selected pallet integration environment shown in pulldown menu 156. If the pallet integration environment is unspecified, than the IPCCR field is empty. Changing the pallet integration environment from the pulldown menu 156 will also cause this field to be updated. The calculated or assigned values for the ICCPR field are obtained from the table of the integration rating coefficients described hereinabove with respect to FIGS. 2D-F. A textual notes fields, Notes₁, Notes₂, Notes₃ . . . Notesᵢ, may also be associated with the name of each module and contain user notes and comments concerning such module for storing in the pallet collection.

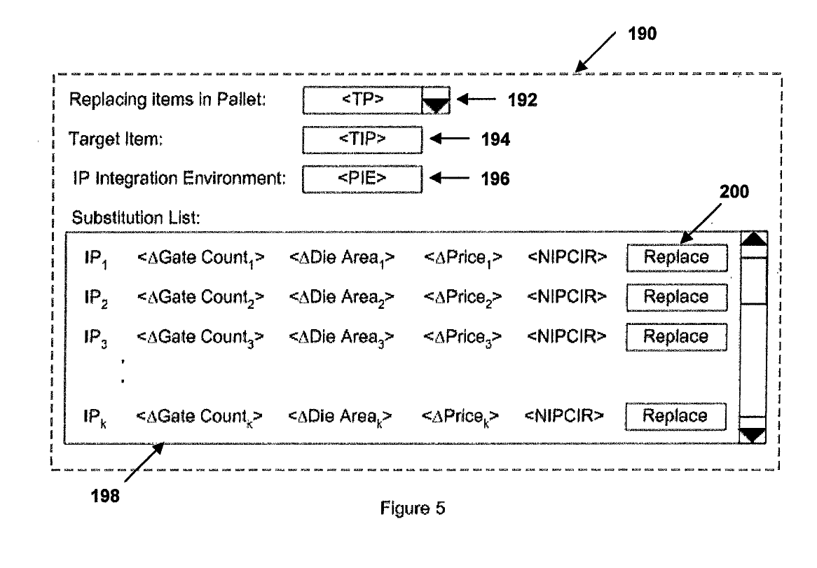

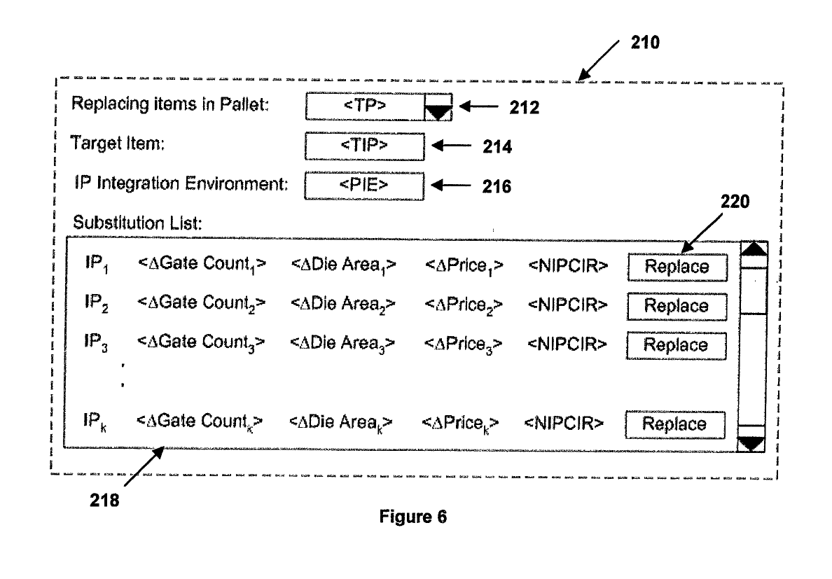

Further associated with the name of each module and the contents list 136 is a delete button 160, a find better match button 162 and a find a programmable or configurable replacement button 164. Selection of the delete button 160 will delete the line entry for its associated module name within the contents list 136, and remove such modules from the stored pallet collection. Selection of the find better match button 162 or the find a programmable or configurable replacement button 164 will open a find better match window described hereinbelow in conjunction with FIG. 5 or to a finding a programmable or configurable replacement window described hereinbelow in conjunction with FIG. 6, respectively.

The parameter banner 138 may include optional text fields such as a gate count field 166, a die area field 168 and a price field 170. The gate count field 166 is a numeric value inserted by the scripts 26 with a number equal to an estimate total number of gates in each of the modules of the current collection within the selected pallet. The die area field 168 is also a numeric value inserted by the scripts 26 with the number equal to an estimate total surface area occupied by the modules in the current collection. The number of gates and die are useful. When the present invention is used for the design of an integrated circuit. However, it is to be understood that the present invention is not to be limited to such application. Finally, the price field 170 contains a numeric value inserted by the scripts 26 with a total price of the collection of modules within the currently selected pallet. Each of these fields within the parameter banner 138 are optional and may take different forms depending on the nature of the device being designed with the integration environment and their respective modules. Furthermore, the numeric values may also be textual values. In any event, such values are obtainable upon changing of the current pallet collection from the pulldown menu 154.

The pallet integration rating coefficients banner 140 includes a variable text field 172 which display is the currently selected pallet integration rating coefficients with the name of one of the tables described hereinabove with reference to FIG. 2D. The banner 140 further includes a display button 174 and a change button 178. Selection of the display button 174 will open the integration rating coefficients window 48 (FIG. 2C). Selection of the change button 178 will open the available tables of integration rating coefficients window 50 (FIG. 2D). Changing of the integration rating coefficients by changing tables will cause the compatibility coefficient ratings, IPCCR, for each of the modules in the contents list 136 to be updated as well as the compatibility integration rating 158 within the banner 134. This banner 140 may also be color coded, textually or in the background, to the value of the pallet integration rating coefficients showed in text field 172.

The delete button 142 will, upon selection, delete the currently selected pallet shown in the pulldown menu 154 from storage and also from the list available pallets 36 (FIG. 2A). Typically, as is well known in the art, a confirmation dialog may be provided to confirm deletion.

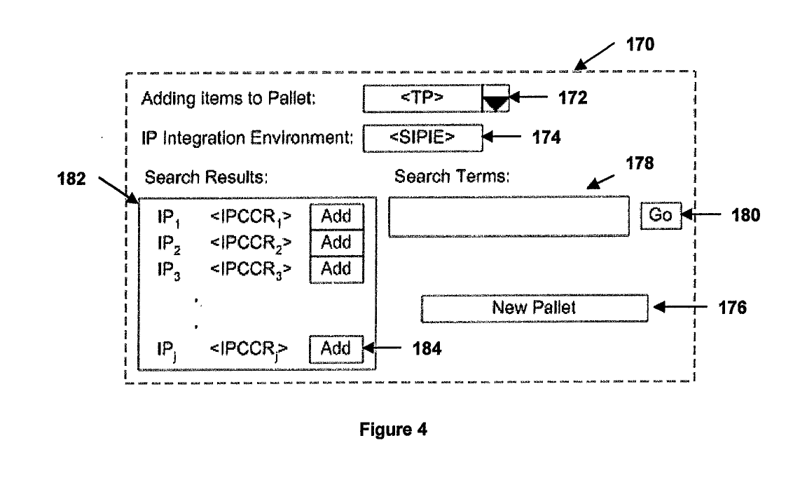

Selection of the add button 144 will open a search window as described hereinbelow in conjunction with FIG. 4. The search window will allow for available IP modules to be obtained and inserted, such as by conventional drag and drop through the graphics user interface of the user computer 12 into the contents list 136.

Selection of the save button 146 will save the current contents in the list 136 under the pallet name shown in the pulldown menu 154. Selection of the save as button 148 will prompt the user for a new pallet name which will also be stored, with the new pallet name then being inserted into the list of available pallet 36.

Selection of either of the optimize within specified integration environment button 150 or optimize considering all integration environments button 152 will open an optimized search window 161, as best seen in FIG. 3B. The optimized search window 161 is a modified form of the view/edit pallet window 130 described hereinabove. Accordingly, elements of the optimized search window 161 having the same reference number as in the view/edit pallet window 130 encompass substantially the same structure and function.

The optimize within specified integration environment button 150 will test all possible combinations of modules within the databases 26 for the currently selected integration environment that have the substantially the same functional description as the items currently in the collection of the pallet set forth in the list 136. The test will select the maximum value from such combinations of the IPCIR, which is inserted into the variable text field 158 of the compatibility integration rating banner 134. The optimize considering all integration environments button 152 will test all possible combinations of modules within all integration environments contained within the pulldown menu 156, wherein such modules have substantial the same functional description as the items currently in the collection of the pallet set forth in the list 136.

The results of either test will be displayed in the optimized search window 161. Accordingly, a modified contents list 163 will contain a listing of the names of each of the modules which results in the optimization. All of the results that can be used to get the optimal score will be placed in the contents list 163. When using either optimize button 150 or 152, and only one integration environment results in an optimal score, only one such optimized search window 161 will be opened. When using the optimize considering all integration environments button 152, and more than one integration environment will result in an equally optimized compatibility integration rating, then an optimized search window 161 for each integration environment, as shown in pulldown menu 156, will be opened.

For example, the contents list 162 may display the partial results of the search wherein three functions, FunctionX, FunctionY and FunctionZ, of the current pallet are present. For FunctionX, two modules, ModuleX1 and ModuleX2, have been found which both results in an equal IPCIR. Since a selection need to be made, the user may select either these modules by selection of a select button 165 associated with each listed module.

For FunctionY, two modules, ModuleY1 and ModuleY2, also have been found. As best seen in FIG. 3B, the user has already selected Module1, and the label of its associated button 165 is changed to Selected, and the button made inactive. In addition, selection of the select button 165 causes a unselect button 167 to be displayed in association with any inactive Selected button. Additionally, the select button 165 for each other module grouped in the same function, for example ModuleY2, will also be made inactive, or preferably, be removed from the window, as seen in FIG. 3B. Selection of the unselect button 167 undoes the actions of the previously selected select button 165 associated therewith.

Finally, if the search has found for any function only one module, then no buttons need be present, or an associated select button may be made inactive. In the example of FIG. 3B, for the function, FunctionZ, only one module, ModuleZ1, is found. Accordingly, there is no associated select button displayed. A cancel button 149 is also provided to enable the user to close the optimized search window 161 without further action. This function may be desirable wherein a module, such as ModuleZ1, in found but for extrinsic reasons known to the user is not desirable.

If the currently selected pallet is empty, i.e., the list 136 (FIG. 3A) does not contain a collection of modules, then selection of either optimize button 150, 152 will cause an error message advising that the pallet is empty to be displayed at the user computer 12 in a pop up window, which may be generated as is conventionally known. If the integration environment in the pulldown window 156 is unspecified, then selection of optimize within the specified integration environment button 152 will cause an error message advising to select an integration environment to be selected to be displayed at the user computer 12 in a pop up window, which may be generated as is conventionally known.

With reference now to FIG. 4, there is shown a search window 170 which is opened upon selection of the start new pallet button 52, or the search IP database button 58, each as best seen in FIG. 2A. The search window 170 includes an add to pallet pulldown menu 172. The initial value shown in the pallet pulldown menu 172 will be the name of the pallet selected from the list 36 if such pallet name has been selected. Otherwise, the default value is “unspecified” if the search window 170 is opened by the search IP database button 58 or the start and pallet button 52.

The search window 170 further includes a text field 174 which displays the integration environment for the target pallet shown in pulldown menu 172. If the target pallet is “unspecified”, the value displayed in text field 174 is the default integration environment shown in the pulldown menu 40 of the default integration environment banner 32. If a value for the target pallet is displayed in the pull down menu 172, the value displayed in text field 174 will then be the integration environment for this target pallet, each of which would be shown in the banner 132 (FIG. 3A) in the pulldown menu 154 and pulldown menu 156.

Also included search window 170 is a new pallet button 176. Upon selection of the new pallet button 176, the user at user computer 12 will be queried, in a manner as is conventionally known, to name the new pallet or accept the default name, which is “Pallet N” wherein “N” is the number of pallets currently saved by this user plus one. Selection of the new pallet button 176 will also open a new view/edit pallet window 130 with the integration environment shown in pulldown menu 156 equal to the integration environment shown in pulldown menu 174. Additionally, the search window 170 may be a window remaining on top of all other windows.

In using the search window 170, the user through the graphic user interface of the user computer 12 will enter search terms into a form input text box 178 and send such search terms for processing by the scripts 24 at the host server 20 by selection of a send or go button 180. Upon processing of the search terms by the scripts 24, the results are returned to a search results user selectable text field 182. The processing of the search terms may be accomplished through any conventionally known search engine acting upon the contents of the databases 26.

In the text field 182 will be displayed each of the located intellectual property modules, IP₁, IP₂, IP₃ . . . IPⱼ, from the database 26, an intellectual property compatibility coefficient rating, IPCCR₁, IPCCR₂, IPCCR₃ . . . IPCCRⱼ, as hereinabove described, associated with each respective one of the intellectual property modules, and an add to pallet button 184 also associated with each of the intellectual property modules.

The intellectual property compatibility coefficient rating for each of the modules will be looked up from the appropriate table, described above, and displayed for each intellectual property module returned, based upon the intellectual property integration environment shown in the pulldown menu 174. However, if this value is “unspecified”, the value for the intellectual property compatibility coefficient rating will also be unspecified. Preferably, the results in the text box 182 are ordered by their respective compatibility coefficient rating, such as from high as to the low list, with unspecified being a default lowest value.

Selection of one of the add to pallet buttons 184 will add the selected intellectual property modules associated therewith to the contents list of the target pallet shown in the view/edit pallet window 30 in the event a target pallet is shown in the pulldown menu 172. Otherwise, the user will get a pop-up warning, generated in the conventional and manner, to select a target pallet from the pulldown menu 172 or to start a new pallet.

With reference now to FIG. 5, there is shown a find better match window 190 which is opened upon selection of a find better match button 162, described hereinabove in conjunction with FIG. 3A. The find better match window 190 is a modified version of the search window 170 (FIG. 4).

The find better match window 190 includes a target pallet pulldown menu 192, which displays the target pallet from the pulldown menu 154 (FIG. 3A), and a target item text field 194, which displays the name of the intellectual property module associated with the find better match button 162 selected by the user at user computer 12. Also included in the find better match window 190 is a pallet integration environment text field 196 which displays the pallet integration environment from the pulldown menu 156 (FIG. 3A).

Selection of the find better match button 162 for the associated intellectual property module will cause a search to be performed, using a conventional search engine to search the items in the database 26, for substitute intellectual property modules, IP₁, IP₂, IP₃ . . . IPₖ, inserted into a substitution list 198 that provide substantially the same function as the associated intellectual property module for which a better match is sought. For each of the substitute intellectual property modules, IP₁, IP₂, IP₃ . . . IPₖ, within the list 198, there is associated therewith a new intellectual property compatibility integration rating, NIPCIR, and a replace button 200.

The new intellectual property compatibility integration rating is a calculated number field with a new rating which the target pallet identified in pulldown menu 192 would have if it were substituted for the target item in the current pallet. All substitute modules found in the search should be displayed in the substitution list 198, irrespective of whether their compatibility integration rating is higher or lower than the compatibility integration rating of the target pallet. Preferably, the substitution list 198 is sorted by the new intellectual property compatibility integration rating in descending order, and furthermore a graphical break may also be made between those that have a compatibility integration rating hired and lower than the capability integration rating of the target pallet. Also, if no substitute modules are found, an error message may also be displayed in the conventional manner.

Selection of one of the replace buttons 200, will delete the target module from the contents list 136 and replace it with the new intellectual property modules associated with the selected replace button 200 from the substitution list 198. Upon the substitution being made, the view/edit window 130 will be returned as the top window at the user computer 12.

The substitution list 198 may also includes three more fields which relate to the banner 138 of the view/edit pallet window 130. Associated with each of the substitute intellectual property modules, IP₁, IP₂, IP₃ . . . IPₖ, is a change of gate count, ΔGateCount₁, ΔGateCount₂, ΔGateCount₃ . . . ΔGateCountₖ, change of die area, ΔDieArea₁, ΔDieArea₂, ΔDieArea₃ . . . ΔDieAreaₖ, and a change of price, ΔPrice₁, ΔPrice₂, ΔPrice₃ . . . ΔPriceₖ, which would respectively reflect the updated values for the gate count field 166, the die area field 168 and a price field 170 in the banner 138 of the view/edit pallet window 130, should the associated substitute intellectual property module replaced and the current target module in the target pallet identified in the pulldown menu 192.

With reference now to FIG. 6, there is shown a programmable or configurable replacement window 210 which is opened upon selection of a find programmable or configurable replacement button 164, described hereinabove in conjunction with FIG. 3A. The programmable or configurable replacement window 210 is also a modified version of the search window 170 (FIG. 4), and substantially similar to the find better match window 190. The substantive differences between each window is that the programmable or configurable replacement window 210 will list, as described below, programmable or configurable modules found in the database 26 that have, for example in the case of integrated circuit design, sufficient gate count capacity, maximum clock rate and other characteristics and parameters required to implement the target module from the list 136. Furthermore, if programmable or configurable blocks exist that already have IP implemented in them with the same functional description as the target module, these blocks will also be listed.

The programmable or configurable replacement window 210 includes a target pallet pulldown menu 212, which displays the target pallet from the pulldown menu 154 (FIG. 3A), and a target item text field 214, which displays the name of the intellectual property module associated with the find programmable or configurable replacement button 164 selected by the user at user computer 12. Also included in the programmable or configurable replacement window 210 is a pallet integration environment text field 216 which displays the pallet integration environment from the pulldown menu 156 (FIG. 3A).

Selection of the programmable or configurable replacement button 164 for the associated intellectual property module will cause a search to be performed, using the conventional certain engine searching the items in the database 26, for substitute intellectual property modules, IP₁, IP₂, IP₃ . . . IPₖ, inserted into a substitution list 218 that can be programmed or configured to provide substantially the same function as the associated intellectual property module. For each of the substitute intellectual property modules, IP₁, IP₂, IP₃ . . . IPₖ, within the list 218, there is associated therewith a new intellectual property compatibility integration rating, NIPCIR, and a replace button 220.

The new intellectual property compatibility integration rating is a calculated number field with the new rating which such module would have if it were substituted for the target item in the current pallet. All substitute modules found in the search should be displayed in the substitution list 218, irrespective of whether their compatibility integration rating is higher or lower than the compatibility integration rating of the target pallet. Preferably, the substitution list 218 is sorted by the new intellectual property compatibility integration rating in descending order, and furthermore a graphical break may also be made between those that have a compatibility integration rating hired and lower than the capability integration rating of the target pallet. Also, if no substitute modules are found, an error message may also be displayed in the conventional manner.

Selection of one of the replace buttons 220, will delete the target module from the contents list 136 and replace it with the new intellectual property modules associated with the selected replace button 220 from the substitution list 218. Upon the substitution being made, the view/edit window 130 will be returned to as the top window at the user computer 12. A functional description of the substituted module may also be updated in the above described notes field.

The substitution list 218 may also includes three more fields which relate to the banner 138 of the view/edit pallet window 130. Associated with each of the substitute intellectual property modules, IP₁, IP₂, IP₃ . . . IPₖ, is a change of gate count, ΔGateCount₁, ΔGateCount₂, ΔGateCount₃ . . . ΔGateCountₖ, change of die area, ΔDieArea₁, ΔDieArea₂, ΔDieArea₃ . . . ΔDieAreaₖ, and a change of price, ΔPrice₁, ΔPrice₂, ΔPrice₃ . . . ΔPriceₖ, which would respectively reflect the updated values for the gate count field 166, the die area field 168 and a price field 170 in the banner 138 of the view/edit pallet window 130, should the associated substitute intellectual property module replaced and the current target module in the target pallet identified in the pulldown menu 212.

There has been described hereinabove novel apparatus and methods for the selection of intellectual property modules. Those skilled in the art may now make numerous uses of and departures from the hereinabove described embodiments without departing from the inventive concepts disclosed herein. Accordingly, the present invention is to be defined solely by the scope of the appended claims.

What is claimed as the invention is:

1. In a computer network including a server and a user device selectively connectable to said server through said network, an apparatus comprising:
a first web page stored at said server and viewable at said user computer, said first web page including an integration environment field and at least one active region, said integration environment field being adapted to contain a user selected one of a plurality of indicia wherein each of said indicia identifies a respective one of a plurality of integration environments, each of said integration environments having a plurality of modules associated therewith, said active region being user selectable when said web page is viewable at said user computer;
a pallet window viewable at said user computer upon selection of said active region, said pallet window including a pallet field and an integration coefficient field, said pallet field being adapted to contain a plurality of second indicia wherein each of said second indicia identifies a respective one of a plurality of modules within all of said integration environments, said integration coefficient field being adapted to contain an integration coefficient computed as a function of a number of said modules from said user selected one of said integration environments and a number of said modules from other ones of said integration environments when said second indicia are contained in said pallet field.

2. An apparatus as set forth in claim 1 wherein said integration environment field initially displays a default one of said first indicia.

3. An apparatus as set forth in claim 2 wherein said first web page further includes a pull down menu, said pull down menu containing said first indicia, any one of said first indicia being user selectable through said pull down menu, said integration environment field being updated to contain said user selected one of said indicia upon user selection.

4. An apparatus as set forth in claim 3 wherein said first web page further includes a banner, said banner containing said indicia field and said pull down menu.

5. An apparatus as set forth in claim 2 wherein said default one of said first indicia is indicative of an undefined state in which none of said integration environments has been selected.

6. An apparatus as set forth in claim 2 wherein one of said first indicia is indicative of an integration environments defined as an integration environment in which said modules are not associated with any predefined integration environment.

7. An apparatus as set forth in claim 1 wherein said pallet window further includes an integration environment field containing a same one of said first indicia presently contained in said integration environment field of said first page.

8. An apparatus as set forth in claim 1 wherein an each of said second indicia are displayed color coded in accordance with in which of said integration environments said respective one of said modules is present.

9. An apparatus as set forth in claim 1 wherein said pallet window further includes a compatibility coefficient field adapted to contain a plurality of compatibility coefficients wherein each of said compatibility coefficients is associated with a respective one of said second indicia, said compatibility coefficients identifying compatibility to said user selected one of said integration environments for each of said modules identified by each respective one of said second indicia.

10. An apparatus as set forth in claim 9 wherein said pallet window further includes a pull down menu, said pull down menu of said pallet window containing said first indicia, said first indicia being user selectable through said pull down menu of said pallet window, said compatibility coefficient field being updated to contain said compatibility coefficients identifying compatibility of each of said modules to a present selected one of said integration environments.

11. An apparatus as set forth in claim 9 wherein said integration coefficient field is updated to contain said integration coefficient computed further as a function of a present selected one of said integration environments.

12. An apparatus as set forth in claim 1 wherein said pallet window further includes a name field adapted to contain a pallet name, said pallet name being associated with a collection of said modules identified by said second indicia contained in said pallet field.

13. An apparatus as set forth in claim 12 wherein said pallet window further includes an active user selectable save region upon selection of which said pallet name and said collection are stored in association with each other.

14. An apparatus as set forth in claim 13 further comprising a database connectable to said server, said collection being stored in said database.

15. An apparatus as set forth in claim 13 wherein said collection is stored at said user computer.

16. An apparatus as set forth in claim 13 wherein said pallet window further includes a pull down menu containing a user selectable pallet name associated with each collection stored, said name field being updated in accordance with selection of said user selectable pallet to name.

17. An apparatus as set forth in claim 13 wherein said pallet field is updated to contain said second indicia of said collection associated with a present one of said pallet name in said name field.

18. An apparatus as set forth in claim 1 wherein said active region includes a new pallet button, said pallet window opening upon said new pallet button being selected.

19. An apparatus as set forth in claim 1 wherein said first page further includes a saved pallet field adapted to contain said pallet name of each stored collection, said pallet name of each stored collection if contained in said saved pallet field being user selectable.

20. An apparatus as set forth in claim 19 wherein said active region includes a view/edit pallet button, said pallet window opening with said second indicia of said modules in said user selected pallet name.

21. An apparatus as set forth in claim 1 wherein said pallet window further includes and upload button, said collection associated with a present pallet named being stored at said user computer upon selection of said upload button.

22. An apparatus as set forth in claim 1 wherein said pallet window further includes a save button, said collection associated with a present pallet name be stored at said server.

23. An apparatus as set forth in claim 1 wherein said pallet window further includes a delete from pallet button selection of which any user selected one of said second indicia is deleted from said pallet field.

24. An apparatus as set forth in claim 1 wherein said pallet window further includes a delete pallet button selection of which deletes said collection associated with a present pallet name and closes said pallette window.

25. An apparatus as set forth in claim 1 further comprising a search window including a search term entry field adapted to receive at least one user entered search term, a search results field adapted to contain any of said second indicia corresponding to respective ones of said modules identified by said search term.

26. An apparatus as set forth in claim 25 wherein said active region further includes search button selection of which opens said search window.

27. An apparatus as set forth in claim 25 further comprising a relational database adapted to be queried by said search term, said database returning matching results to said search results field.

28. An apparatus as set forth in claim 25 wherein said search window further includes a target pallet field adapted to contain one pallet name of any said pallet window, said search window further including a compatibility coefficient field containing said compatibility coefficient for each of said second indicia contained in said search results field according to said first indicia contained in said pallet window.

29. An apparatus as set forth in claim 28 wherein said pallet window further includes an integration environment name field adapted to containing a same one of said first indicia contained in said pallet window.

30. An apparatus as set forth in claim 28 wherein said search window further includes an add to pallet button selection of which adds a present contents of said search results window to said pallet field of said pallet window identified in said pallet name field.

31. An apparatus as set forth in claim 30 further comprising a pop up window to instruct a user to select a pallet name in the event said pallet name field is empty.

32. An apparatus as set forth in claim 31 wherein said search window further includes a pull down menu containing user selectable ones of each pallet name.

33. An apparatus as set forth in claim 30 wherein said search window further includes a start new pallet active button selection of which opens a new pallet window.

34. An apparatus as set forth in claim 1 wherein said server includes a login script, said login script being executable upon attempted access of said first web page from said user computer wherein successful execution of said login script allows access to said first web page.

35. An apparatus as set forth in claim 1 further comprising a display coefficients window displayed in response to selection of a display coefficients button on said pallet window, said display coefficients window containing a table of integration rating coefficients.

36. An apparatus as set forth in claim 35 wherein said table includes a list of said integration environment's displayed along an abscissa and the integration environment that the particular intellectual property module is designed for being displayed along the ordinate, the integration environment being displayed being numeric valley is relating to the relative ease of using electoral property modules designed for one particular integration environment within any other integration environment.

37. An apparatus as set forth in claim 35 wherein said table of integration rating coefficients is a unity table.

38. An apparatus as set forth in claim 35 wherein said table of integration rating coefficients is a recommended table of predetermined coefficients.

39. An apparatus as set forth in claim 35 wherein said table of integration rating coefficients contained user editable values.

40. An apparatus as set forth in claim 35 wherein said display coefficients window contains a plurality of the indicia, each of said indicia representing a respective one of a plurality of tables of integration rating coefficients, selected ones of said tables being user editable.

41. An apparatus as set forth in claim 40 wherein each of said indicia of for said user editable tables further display a version number incremented after each edit thereof.

42. An apparatus as set forth in claim 1 further comprising a quick calculator window displayed in response to selection of a quick calculator button on said first web page, said quick calculator window providing a scratchpad window wherein the user contested various combinations of modules to compute said integration coefficient.

43. An apparatus as set forth in claim 42 wherein said quick calculator window includes a plurality of indicia wherein each of said indicia identifies a calculation formula, each of said indicia being selectable to change of formula used to compute said integration coefficient.

44. An apparatus as set forth in claim 43 further comprising an enter/edit formula window displayed in response to selection of and enter formula button on said quick calculator window, said formula window providing an interface to selectively edit existing formula and enter new formula.

45. An apparatus as set forth in claim 1 further comprising an optimized search window displayed in response to selection of an optimize button from said pallet window, said optimized search window including a plurality of indicia identifying substitute modules for selected modules in said pallet window, wherein said substitute modules have a compatibility coefficient indicating a greater degree of compatibility that said selected modules.

46. An apparatus as set forth in claim 45 wherein said optimized search window includes a select button associated with each of said indicia for said substitute modules, wherein selection of said select button replaces said substitute module associated there with in said pallet window for one of said selected modules.

47. An apparatus as set forth in claim 46 wherein said optimized search window includes an unselect button associated with each of said indicia for said substitute modules, wherein selection of said unselect button reverses any action taken by selection of said select button associated therewith.

48. An apparatus as set forth in claim 47 wherein said unselect button is made visible only subsequent to selection of said select button.

49. An apparatus as set forth in claim 1 wherein said pallet window includes a find better match button associated with each of said indicia of identifying said modules.

50. An apparatus as set forth in claim 49 wherein is selection of said find better match button will search for modules having at greater degree of compatibility that said module identified by said indicia associated with said find better match button.

51. An apparatus as set forth in claim 1 wherein each of said first page and said pallet window contain a pulldown menu having a listing of each of said integration environment, wherein selection of any integration environment recomputes said compatibility coefficient.
